(19) United States
(12) Patent Application Publication
(10) Pub. No.: US 2023/0267372 A1
(43) Pub. Date: Aug. 24, 2023

(54) HYPER-EFFICIENT, PRIVACY-PRESERVING ARTIFICIAL INTELLIGENCE SYSTEM

(71) Applicant: SliceX AI, Inc., Menlo Park, CA (US)

(72) Inventor: Sujith Ravi, Menlo Park, CA (US)

(21) Appl. No.: 18/112,917

(22) Filed: Feb. 22, 2023

Related U.S. Application Data
(60) Provisional application No. 63/313,657, filed on Feb. 24, 2022.
(60) Provisional application No. 63/313,658, filed on Feb. 24, 2022.

(51) Int. Cl. G06N 20/00; H04L 9/08; H04L 9/30

(52) U.S. Cl. CPC G06N 20/00; H04L 9/0861; H04L 9/30

(57) ABSTRACT

A method and system for training a machine learning model include receiving user information for a user, generating a private key and a public key for the user based on the user information, receiving input bytes containing user-specific features, feeding the input bytes, the private key, and the public key into a machine learning model, training the machine learning model based on the received input bytes, the private key, and the public key, and generating a personalized machine learning model for the user based on the training of the machine learning model.

### CROSS REFERENCE TO RELATED APPLICATION

This application claims the benefit of and priority to U.S. Provisional Pat. Application No. 63/313,657 filed Feb. 24, 2022, and entitled “HYPER-EFFICIENT, PRIVACY-PRESERVING ARTIFICIAL INTELLIGENCE SYSTEM,” and U.S. Provisional Pat. Application No. 63/313,658 filed Feb. 24, 2022, and entitled “END-TO-END ARTIFICIAL INTELLIGENCE SYSTEM WITH UNIVERSAL TRAINING AND DEPLOYMENT,” the entire disclosure of each of which is hereby incorporated by reference in its entirety for all purposes. This application is also related to co-pending U.S. Application No. ______, filed on the same date as this application by inventor Sujith Ravi, entitled “END-TO-END ARTIFICIAL INTELLIGENCE SYSTEM WITH UNIVERSAL TRAINING AND DEPLOYMENT,” the entirety disclosure of which is hereby incorporated by reference in its entirety for all purposes.

### TECHNICAL FIELD

This disclosure generally relates to the field of artificial intelligence technology, and more particularly to hyper-efficient and privacy-preserving artificial intelligent systems with improved safety and efficiency.

### BACKGROUND

Artificial intelligence is one of the key technologies that transform the world nowadays. It is a wide-ranging tool that enables people to ingest information, analyze data, and use the obtained insights to improve decision-making. In traditional machine learning, large servers are often used to process heaps of data collected from the internet to provide insightful information, but they have limitations. For example, data traveling to and from large servers and the cloud over the internet causes safety concerns. In addition, transferring data to the servers in the cloud for training also is often time-consuming, and thus causes latency in the model training and development.

Deploying and training machine learning models on edge devices may address some but all of the safety concerns. For example, edge devices generally are less equipped with safety measures than large servers, which makes them an easy target for hackers or other online frauds. In addition, due to the large difference in computation resources, power supply, and network connection among different edge devices, a developed machine learning model for edge devices may not perform well in all target edge devices. Furthermore, different users may have different interests and preferences, and a machine learning model developed for all edge devices or users may not capture the interests and preferences of specific individuals.

### SUMMARY

To address the aforementioned shortcomings, a method and system for training a privacy-preserving and personalized machine learning model are provided. The method includes receiving user information for a user, generating a private key and a public key for the user based on the user information, receiving input bytes containing user-specific features, feeding the input bytes, the private key, and the public key into a machine learning model, training the machine learning model based on the received input bytes, the private key, and the public key, and generating a personalized machine learning model for the user based on the training of the machine learning model.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The disclosed embodiments have advantages and features which will be more readily apparent from the detailed description, the appended claims, and the accompanying figures (or drawings). A brief introduction of the figures is below.

FIG. 1 is a block diagram of an example model management system, according to embodiments of the disclosure.

FIG. 2 is a block diagram of example components included in a model management application, according to embodiments of the disclosure.

FIG. 3A illustrates an example application scenario for training personalized AI engines, according to embodiments of the disclosure.

FIG. 3B illustrates an example application scenario for training a device-specific personalized AI engine, according to embodiments of the disclosure.

FIGS. 4A-4B illustrate an example process for generating a private key and a public key based on the user-ID and password, according to embodiments of the disclosure.

FIGS. 5A-5D collaboratively illustrate an example process for training a personalized AI engine based on a private key and a public key, according to embodiments of the disclosure.

FIG. 6 illustrates an example process for training a personalized AI engine based on a private key and a public key of a user, according to embodiments of the disclosure.

FIGS. 7A-7C illustrate various example application scenarios for accessing a personalized AI engine by different users, according to embodiments of the disclosure.

FIGS. 8A-8C illustrate different levels of privacy protection, according to embodiments of the disclosure.

FIG. 9 is a block diagram of an example computer for a model management system, according to embodiments of the disclosure.

### DETAILED DESCRIPTION

The Figures (FIGS.) and the following description relate to some embodiments by way of illustration only. It should be noted that from the following description, alternative embodiments of the structures and methods disclosed herein will be readily recognized as viable alternatives that may be employed without departing from the principles of the disclosure.

Reference will now be made in detail to several embodiments, examples of which are illustrated in the accompanying figures. It is to be noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

As described earlier, deploying machine learning models to edge devices face technical problems or limitations due to safety concerns and due to the different device constraints among edge devices. The technical solutions disclosed herein address these technical problems by providing hyper-efficient and privacy-preserving artificial intelligent (AI) systems that enable multiple layers of privacy for users (or enterprises), which are also hyper-efficient (e.g., fast to run, only require a low memory footprint, and also cost-effective).

According to one embodiment, the disclosed artificial intelligence systems allow to develop a machine learning model or a set of machine learning models that can be customized to cater to specific user interests and preferences. For example, the disclosed artificial intelligence systems allow to train a machine learning model using personal data or information that reflects user interests and preferences. Such personal data or information, when applied to a model training process, may tune the weights and/or biases of the trained machine model towards the user interests and preferences.

To address the safety concerns, the disclosed artificial intelligence systems also allow to train a machine learning model by using certain encryption technologies, so that a trained machine learning model can be a private model that only functions properly until proper personal information is provided.

Further, the disclosed artificial intelligence systems may allow to develop a set of machine learning models for a same application based on the device constraints of all possible target devices, where each of the set of machine learning models may be suitable for a subset of all target edge devices. For example, a first model of the set may be developed for edge devices with a high computation performance, a second model of the set may be developed for edge devices with a medium computation performance, and a third model of the set may be developed for edge devices with a low computation performance.

The artificial intelligence systems disclosed herein may show advantages over other existing machine learning systems. For example, since a machine learning model is encrypted through the training process, the model may function properly until proper personal information is provided. This not only increases the safety of the user information or data associated with a personalized model, but also prevents the unnecessary running of a personalized model by other users, which then saves the computation resources and other resources of an edge device. In addition, by personalizing a model, more user-customized information may be displayed to a user by the model, which then does not require a user to go through additional searches (e.g., more flips on a wearable device) to find the desired information. This also saves the energy source, the network bandwidth, and/or the computation resource of an edge device, which may significantly affect the operation of edge devices, especially the ones with limited computation resources/energy source/bandwidth, such as wearable devices, VR/AR, embedded systems, and so on. Furthermore, since each machine learning model disclosed herein is developed and optimized based on the device constraints, each machine learning model may perform better in a specific edge device when compared to a machine learning model that is developed for all edge devices with various constraints. The efficiency of the disclosed machine learning systems is thus improved.

It is to be noted that the benefits and advantages described herein are not all-inclusive, and many additional features and advantages will be apparent to one of ordinary skill in the art in view of the figures and the following descriptions.

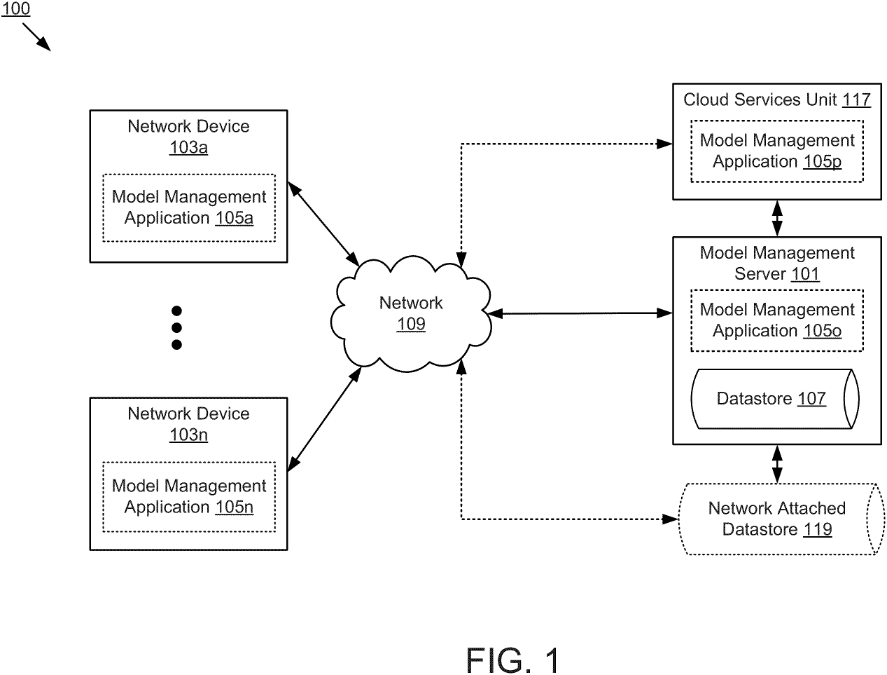

FIG. 1 is a block diagram of hardware components for a machine learning system, which may be also referred to as a “model management system” due to its focus on the model development and training processes. As illustrated, the model management system 100 may be a network-based specialized computer environment configured to efficiently develop and deploy a machine learning model or a set of machine learning models (may be simply referred to as “models”) or AI engines, which can be scaled to different domains and business needs across different platforms, devices, and modalities. As illustrated in FIG. 1, the model management system 100 may include one or more specialized computers or other machines that are configured to develop, train, and deploy machine learning models, and/or apply the deployed machine learning models (e.g., by reference engine) for content recommendation, auto-messaging, document classification, anomaly detection, user authentication, and many other applications.

In one embodiment, the model management system 100 includes one or more general network devices, such as edge devices 103 that may communicate with other components of the system through network 109. For example, edge devices 103 may collect and send data to the model management server 101 to be processed, and/or may receive machine learning models developed by the model management server 101, among other activities. In an edge computing network aimed to reduce the bandwidth costs associated with moving raw data from where it was either an enterprise data center or the cloud, edge devices are devices that connect to a nearby module for more responsive processing and smoother operations. In one example, edge devices 103 may include desktop computers, laptops, handheld or mobile devices, personal digital assistants, wearable devices, Internet of things (IoT) devices, network sensors, databases, embedded systems, virtual reality (VR)/augmented reality (AR) devices, or many other devices that may transmit or otherwise provide data to the model development server 101.

In some embodiments, in addition to collecting data to be transmitted as part of a model development process (e.g., collecting data for model training and testing purposes), edge devices 103 may also receive machine learning models developed by the model management server 101, and further apply the received machine learning models or AI engines for specific applications. For example, an edge device 103 may receive a machine learning model specifically developed for the edge device or a family of devices similar to the edge device 103, which can be further specifically trained for a user associated with the edge device, according to some embodiments. The edge device may apply the specifically developed machine model for applications. Since the machine learning model is specifically trained for the user associated with the device, when the model is applied, more user-specific features may be output by the personalized model, which then improves the efficiency of the disclosed machine learning system. In addition, since the machine learning model is specifically developed for the edge device or a family of devices that have similar device constraints, the machine learning model may be optimized during the model development and thus have a better performance than a machine learning model that is developed without considering constraints existing in the edge device 103.

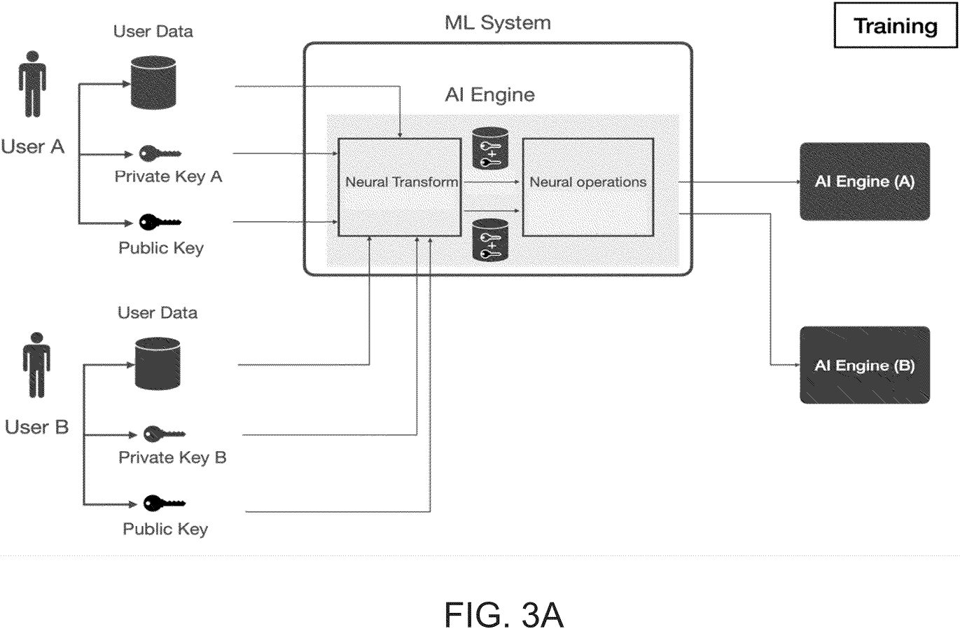

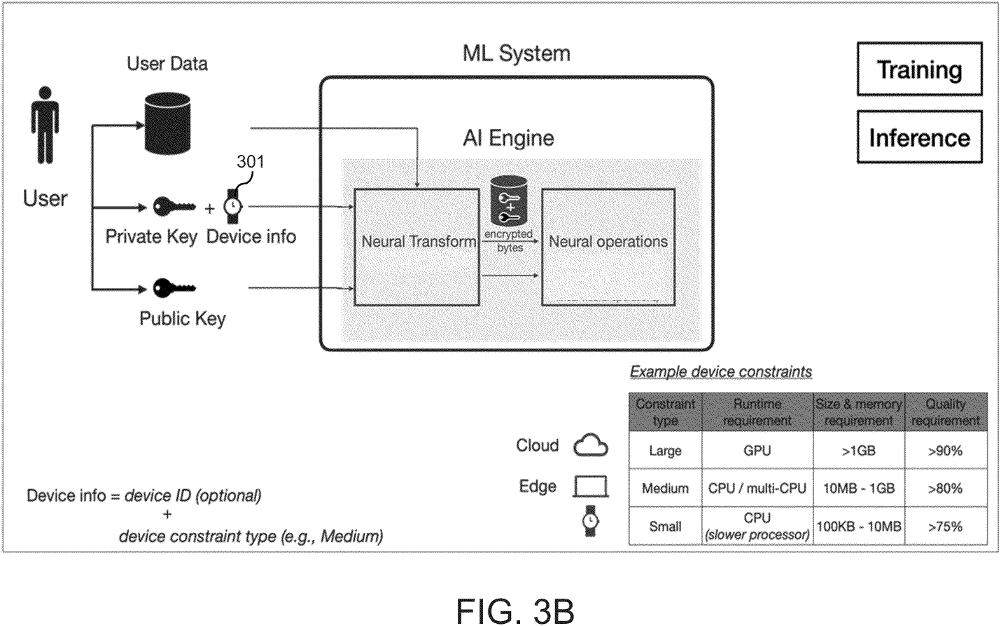

In some embodiments, edge devices 103 may be classified into different families based on the device constraints, such as processing capacity, runtime requirement, memory size, accessibility, and other properties of the devices, which generally reflect a computation power of a device. In some embodiments, the device constraints may also include the quality requirement (e.g., a score range) for the machine learning model output for the devices. In some embodiments, the edge devices 103 may be classified into three, four, five, or even a larger number of families, where each family may show a difference with respect to the device constraints. In one example, as illustrated in FIG. 3B, the edge devices 103 may be classified into three families based on the device constraint type (i.e., large, medium, small). An enterprise server for an enterprise or an edge server for an online service provider may be classified as a “large” edge device due to its quicker processor, larger memory size, and higher quality requirement. A wearable device or an IoT device and the like may be classified as a “small” edge device, due to its slower processor, smaller memory size, and lower quality requirement. A personal computer or laptop and the like may be classified as a “medium” edge device due to its decent processing capacity, memory size, and quality requirement.

In some embodiments, edge devices 103 may also perform processing on data they collect before transmitting the data to the model management server 101, or before deciding whether to transmit the data to the model management server 101. For example, edge devices 103 may determine whether the collected data meets certain rules, for example, by comparing data or values calculated from the data to one or more thresholds. Edge devices 103 may use this data and/or comparisons to determine if the data should be transmitted to the model management server 101 for data handling and/or processing (e.g., for machine learning model training and/or testing). Data with or without processing may be transmitted by edge devices 103 directly to the model management server 101 or network-attached data store, such as network-attached datastore 119 for storage so that the data may be retrieved later by the model management server 101 or other components of the model management system 100.

The model management system 100 may also include one or more network-attached datastore 119. Network-attached datastore 119 may be configured to store data managed by the model management server 101 as well as any intermediate or final data (e.g., untrained or trained machine learning models) generated by the model management system 100 in non-volatile memory. However, in certain embodiments, the configuration of the model management server 101 allows its operations to be performed such that intermediate and final data results may be stored solely in volatile memory, without a requirement that intermediate or final data results (e.g., intermediate parameters and weights obtained during the model training processes) be stored in non-volatile types of memory, e.g., network-attached datastore 119.

Network-attached datastore 119 may store a variety of different types of data organized in a variety of different ways and from a variety of different sources. For example, network-attached datastore 119 may store unstructured (e.g., raw) data, such as social media, emails, messages, stock market charts, etc. The unstructured data may be presented to the model management server 101 in different forms such as a flat file or a conglomerate of data records, and may have data values and timestamps. The model management server 101 may be configured to analyze and/or annotate the unstructured data in a variety of ways to determine the best way to structure (e.g., hierarchically) that data, such that the structured data is tailored to a type of further analysis that a user wishes to perform on the data. For example, after being processed, the unstructured timestamped data may be aggregated by time (e.g., into daily time period units) to generate time series data (e.g., time series data for automotive applications) and/or structured hierarchically according to one or more dimensions (e.g., parameters, attributes, and/or variables). For example, data may be stored in a hierarchical data structure, or may be stored in a tabular form. In some embodiments, the analyzed or annotated data may facilitate the preparation of data for testing and/or training machine learning models developed by the model management server 101. In some embodiments, the data analysis and annotation may be performed on an edge device instead (e.g., on a model management application 105a/105n residing on an edge device 103a/103n), to minimize network consumption.

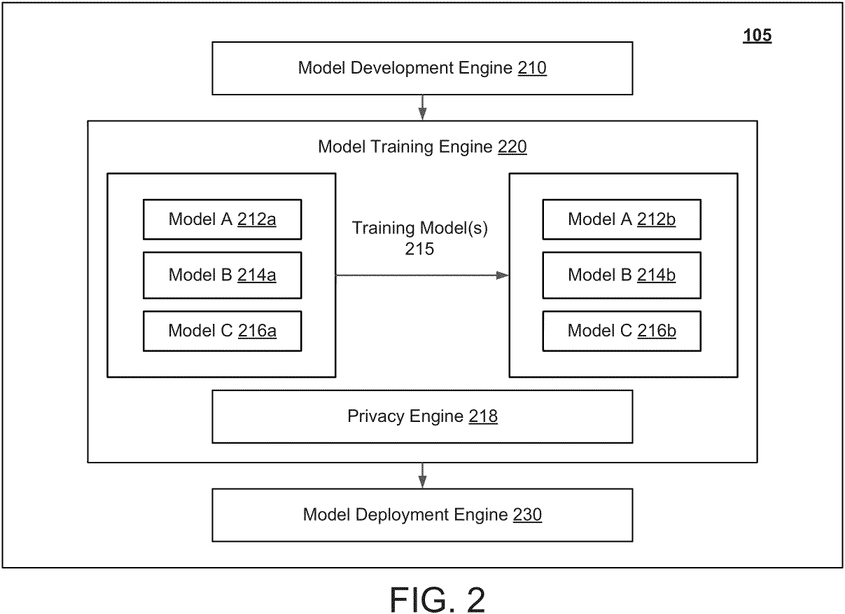

In some embodiments, besides data analysis and/or annotation, the model management server 101 may be configured to develop machine learning models customized based on the user data and/or the device constraints. For example, the model management server 101 may include an instance of model management application 105o configured to develop and train a machine learning model or a set of machine learning models that may be customized based on the user information and/or device information. For a machine learning model trained based on the user information, the machine learning model may generate an output containing customized features reflecting the user interests or preferences. For a machine learning model developed based on the device information, the developed machine learning model may be trained to perform well in that device or in other similar devices that show similar processing capacity. In some embodiments, the instance of model management application 105o may include one or more of the model development engine, model training engine, or model deployment engine configured for model development, training, and further deployment, as further described in detail in FIG. 2.

In some embodiments, the edge devices 103 may also include a model management application 105a or 105n. The instance of model management application 105a or 105n may be similarly configured to develop, train, and deploy one or more machine learning models. In some embodiments, besides model development and deployment, the instance of model management application 105a or 105n may be further configured to apply the machine learning models for specific applications. For example, the instance of model management application 105a or 105n may further include an inference engine configured to access a trained machine learning model and apply the model to process incoming data (e.g., text document) to generate a final output (e.g., a document category if the machine learning model is a document classifier). In some embodiments, an edge device 103 may be configured to merely include an inference engine without including a model development function, or vice versa.

In some embodiments, the model management system 100 may additionally include one or more cloud services units 117. Cloud services unit 117 may include a cloud infrastructure system that provides cloud services. In some embodiments, the computers, servers, and/or systems that make up the cloud services unit 117 are different from a user or an organization’s own on-premise computers, servers, and/or systems. For example, the cloud services unit 117 may host an application (e.g., a model management application 105p), and a user may, via a communication network, order and use the application on-demand. In some embodiments, services provided by the cloud services unit 117 may include a host of services that are made available to users of the cloud infrastructure system on demand. For example, the services provided by the cloud services unit 117 may include machine learning model development, training, and deployment. Additionally or alternatively, the services provided by the cloud services unit 117 may merely include hosting trained machine learning models for use by online users. In some embodiments, the cloud services unit 117 may be also a server for providing third-party services, such as messaging, emailing, social networking, data processing, image processing, or any other services accessible to online users or edge devices. In some embodiments, the cloud services unit 117 may include multiple service units that each is configured to provide one or more of the above-described functions or other functions not described above.

In some embodiments, services provided by the cloud services unit 117 may dynamically scale to meet the needs of its users. For example, cloud services unit 117 may house one or more model management applications 105p for model development, training, and deployment, which may be scaled up and down based on the number and complexity of machine learning models being developed or to be developed. Accordingly, in one embodiment, cloud services unit 117 may be utilized by the model management server 101 as a part of the extension of the server, e.g., through a direct connection to the server or through a network-mediated connection.

Communications within the model management system 100 may occur over one or more networks 109. Networks 109 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or a combination of wireless interfaces. As an example, a network in one or more networks 109 may include a short-range communication channel, such as a Bluetooth or a Bluetooth Low Energy channel. A wired network may include a wired interface. The wired and/or wireless networks may be implemented using routers, access points, bridges, gateways, or the like, to connect devices in the system 100. The one or more networks 109 may be incorporated entirely within or may include an intranet, an extranet, or a combination thereof. In one embodiment, communications between two or more systems and/or devices may be achieved by a secure communications protocol, such as a secure sockets layer or transport layer security. In addition, data and/or transactional details may be encrypted (e.g., through symmetric or asymmetric encryption).

In some embodiments, the model management server 101 may further include a data store 107 configured for managing, storing, and retrieving data that is distributed to and stored in one or more network-attached datastores 119 or other datastores that reside at different locations (e.g., within an edge device) within the model management system 100.

It is to be noted that, while each edge device 103, server 101, and cloud services unit 117 in FIG. 1 is shown as a single device, it will be appreciated that multiple devices may be used instead. For example, a set of edge devices may be used to transmit various communications from a single user or different users, or the model management server 101 may include a server stack. As another example, data may be processed as part of the model management server 101. As yet another example, edge device 103 may be a part of the model management server 101, and cloud services unit 117 and/or network-attached datastore 119 may be not included in the model management system 100.

In addition, the functions included in each instance of model management application 105a/105n/105o/105p (together or individually referred to as “model management application 105”) in different devices may be different. In some embodiments, different instances of application 105 from different devices collaboratively complete one or more functions. For example, one or more edge devices 103 and the model management server 101 may collaboratively train a machine learning model(s). In the following, model management application 105 included in the model management server 101, edge devices 103, or cloud services unit 117 will be described further in detail with reference to specific engines, modules, or components, and their associated functions.

FIG. 2 illustrates example components included in a model management application 105, according to embodiments of the disclosure. As illustrated in the figure, a model management application 105 may include a model development engine 210, a model training engine 220, and a model deployment engine 230. In some embodiments, a model management application 105 may further include an inference engine (not shown) that uses a trained machine learning model for the specific application. It should be noted that not every model management application includes all engines 210-230. Depending on the residing device, a model management application 105 may include fewer components than those illustrated in FIG. 2. In one example, a model management server 101 may not include an inference engine, while an edge device 103 may only include an inference engine. In another example, an edge device 105 may include all components mentioned here.

The model development engine 210 may be configured to develop machine learning models for specific applications. Based on the purposes of specific applications, the machine learning models developed by the model development engine 210 may include a large number of machine learning model sets configured toward different applications. The possible applications for these machine learning models may include but are not limited to:
Content detection
Sentiment analysis - detecting sentiment (e.g., sentiment towards products expressed in customer reviews)
Emotion recognition - detecting an emotional aspect of user content (e.g., messages, tweets)
Document/posts/message/email categorization - (e.g., categorize news article or headline into business vs. sports vs. technology)
Anomaly detection - (e.g., identifying unusual activity in banking accounts)
Legal discovery
Product categorization (for shopping) - from text, image
Personalized object detection (from images, videos)
Content recommendation
News recommender system
Query understanding
Photo finder
Search (on personal devices)
Personalized auto-completion for messaging
Content filtering
Hate-speech detection - filter hateful content in social media (messages, tweets, etc.)
PII filtering - identify and remove personally-identifiable content from documents, transaction reports, etc.
Sensitive content detection - filter sensitive (or harmful) content from user-generated data (e.g., comments)
User and conversational AI (e.g., chatbots)
Intent detection - automatically recognize intent expressed in conversations between user-to-machine or user-to-user settings (e.g., I am interested in the new Macbook® → purchase intent)
Personalized virtual assistants - personalize smart home assistants while maintaining privacy (e.g., customize commands, smart actions, and execution routines for individual users).
User authentication - use user input/features to authenticate on a device
Fraud prevention - tackle payment and sensitive information fraud to detect and prevent fraud activities of information
Automated stock trading (e.g., AI-based high-frequency trading platforms)
Computer vision - derive meaningful information from digital images, videos, and other visual inputs
Discovery of data trends (e.g., use consumers’ behavior to discover data trends)

The application scenarios of these machine learning models may relate to, but are not limited to the following: search, advertisements (Ads), messaging and email, shopping, social media, virtual assistants, smart home, automotive, augmented reality (AR)/virtual reality (VR), news, health, finance and law, human resources (HR) integration systems, embedded systems, etc.

In some embodiments, the model development engine 210 may be configured to develop a set of machine learning models for a single specific application (e.g. document classification), as described elsewhere herein. Not like many other machine learning systems that focus on the operating systems of the target devices (e.g., developing different machine learning models for iPhone® and Android devices), the disclosed model development engine 210 is more focused on the device constraints associated with the target devices, among other possible factors (e.g., user information) that may also affect the model development. In one example, based on the device constraints, the model development engine 210 may develop, for a single application, a set of machine learning models that respectively fit the target devices with different constraints.

For example, the model development engine 210 may develop three or more machine learning models that have the same purpose but with different performances. Each of these machine learning models may be suitable for application in a subset of the target devices. For example, a first machine learning model may perform well on wearable devices that have limited processing capacity and memory size, and a second machine learning model may perform well on a personal computer, a laptop, a cell phone or tablet, or another device that has a decent processing capacity, and a third machine learning model may perform well on an enterprise server or cloud service-implementing device that has a much larger processing capacity and/or memory size. In some embodiments, based on how the device constraints of the target devices are categorized, the set of machine learning models may include three, four, five, six, seven, or even a larger number of machine learning models that have the same function (e.g., content classification). By increasing the number of machine learning models in each set, the performance of corresponding models may be improved, since there will be less gap in performance when there are more models developed for a same application.

In some embodiments, the model development engine 210 may first determine all possible target devices capable of running an application (or a trained AI engine), and then identify constraints among all possible target devices, but not other devices that are incapable of running the application. For example, if a set of machine learning models are being developed for an automotive-related application, only the devices (e.g., devices with necessary video, audio, and/or laser-detection sensors) that can be used for the automotive-related application are considered in identifying the constraints of the target devices. For another example, if a set of machine learning models are being developed for an AR/VR-related application, then the AR/VR devices, but not other devices, are evaluated in identifying the constraints of the target devices. Accordingly, when categorizing the device constraints, due to the possible different target devices for different applications, the criteria used in the categorizing process may be also different.

As described earlier, the machine learning models developed for target devices with different constraints may have different performances. This is mainly due to the complexity of the algorithms added to each model in the set of machine learning models. While some basic functions may be achieved through a basic algorithm, by including more complexity, the performance of an algorithm may be improved. For example, for objection detection from an image, a neuron network with three layers may achieve the basic function in object detection. However, by increasing the neuron network to five layers, the accuracy in object detection may be improved, due to additional features considered through the added two more layers in object detection. If the neuron network is further improved to include ten layers, the accuracy of the machine learning model in object detection can be further improved.

In some embodiments, the algorithm of machine learning models with different complexities may preferably match the device constraints of applicable devices. Accordingly, each machine learning model in the developed set of machine learning models is expected to be deployed to a family of devices with the corresponding device constraints.

The model training engine 220 is configured to train the machine learning models developed by the model development engine 210. For instance, for a set of machine learning models developed by the model development engine 210, such as model A 212a, model B 214a, and model C 216a, each model may be trained through a model training process 215, to obtain the trained model A 212b, model B 214b, and model C 216b, as illustrated in FIG. 2. Depending on the application, the machine learning model, and the available data for training, different training processes may be used by the model training engine 220. For example, the training process 215 can be supervised, semi-supervised, or unsupervised training. In one example, the training of a neural network includes feeding the neural network with input data, and adjusting the values of the elements of the weight arrays W₁, W₂, . . . Wₙ and/or bias vectors b₁, b₂, b₃, . . . bₙ, so that the output of the neural network is closer to the required output for the input data. This is repeated many times (e.g., iterations) until the neural network is properly trained (e.g., model weights are finalized when there is not much decrease in error).

In some embodiments, a machine learning model may be trained by including private user information to obtain a private machine learning model (or personalized model). That is, a trained machine learning model is user-specific. Towards this objective, the model training unit 220 may optionally include a privacy engine 218 configured to train a machine learning model with provided user information (e.g., user-ID) and optionally information for the application so that the model weights are optimized for the specific user and application. For example, a personalized content detection or recommendation engine, if trained with user information, may filter messages or social media posts, tweets, and the like based on user information (e.g., user preferences) and surface only posts that pertain to user-interested topics (e.g., crypto).

In some embodiments, user data of multiple different users may be used to train and personalize the machine learning models on individual data and specific applications to produce different and private versions of the AI engine tailored to their individual needs. For example, user A may train a topic detection system to narrow down and recognize posts specifically related to “baseball,” whereas user B may train the engine to surface tennis-related posts instead. All other generic users may see posts about broader topics (e.g., sports or politics in general) if the AI engine is not trained with personal information for these users. As another example, an enterprise with multiple divisions may use the privacy engine 218 to train different AI engines (i.e., different versions of a machine learning model) that cater to different cohorts of customers. The enterprise may then choose to grant/deny certain divisions access to the AI engine in a selective manner using the private sharing option. For example, a customer service chatbot can be trained and accessed by the finance division to help with banking or payment issues, whereas the same chatbot can be also trained and used by the IT division to respond differently to IT/technical issues. As a result, once trained, the AI engine is automatically and natively privacy-preserving.

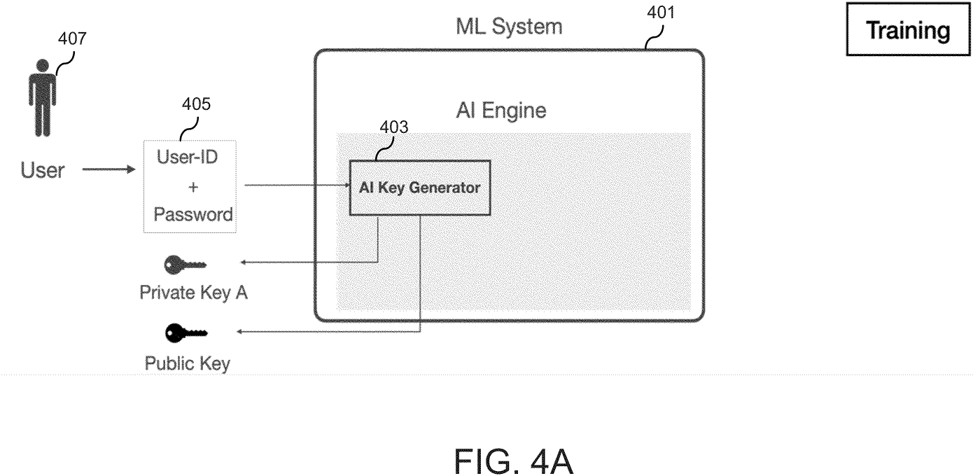

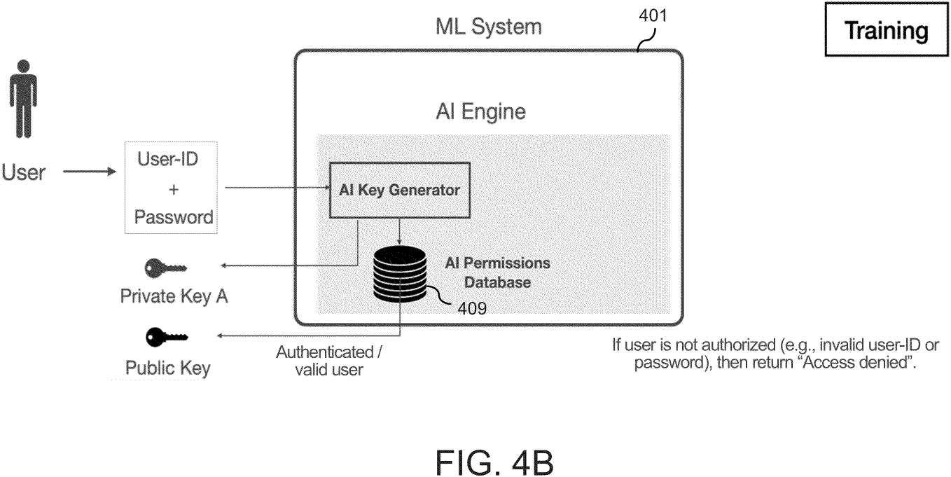

In some embodiments, the privacy engine 218 may be configured to enable password/personal key protection for a machine learning model. In one embodiment, the machine learning models disclosed herein may be configured to operate in an encrypted mode, which means that computations by the disclosed machine learning models may be carried out on hypertext, thereby generating an encrypted result that, when decrypted, matches the result of operations performed on the plaintext. Since only the hypertext (e.g., encrypted data) is used during the process, it is neither feasible nor practical to reverse-engineer nor recover the original user input data from the model’s final or intermediate output. Even if a third party gets access to the machine learning system (e.g., from memory or disk), they will not be able to gain access to the user’s private data through the machine learning system. Instead, a user may only access and generate the right model predictions using the correct password/personal key that was originally used to train or personalize the model. The specific detail for training a privacy-reserving machine learning model is further described in detail in FIGS. 4-6.

In some embodiments, the model training process can be implemented on an edge device 103, the model management server 101, or the cloud services unit 117. For a machine learning model trained on the model management server 101 or the cloud services unit 117, due to the availability of a high-performance computing platform, the same set of machine learning models developed for devices with different constraints can be all trained on the model management server 101 or the cloud services unit 117. For a machine learning model trained on an edge device 103 that has limited computation power, only a model corresponding to its device constraints or devices having greater constraints may be trained on that edge device, while the other models in the model set are not trained on that edge device 103. For example, a “medium” device may be used to train models for “medium” or “small” devices, while a “small” device may be only used to train models for “small” devices.

In some embodiments, to acquire a proper model for training on the edge device 103, the edge device information (e.g., device constraints) along with input specifications (which may indicate which kind of application) may be transmitted to the model management server 101. Depending on the device information and input specification, the model management server 101 may select (or instantiate one if there is no existing one) a machine learning model suitable for the device type. For example, if the edge device is a GPU machine running on a desktop, the model management server 101 may select a machine learning model that uses a lot of parameters, e.g., a model for neural transform operations (e.g., text documents are transformed from string inputs to byte/bit-encoding representations) that use a large number of bits and have a big architecture (e.g., 100 million or billion parameters). On the other hand, if the edge device is a mobile phone with much smaller computation and memory capacity, the model management server 101 may select a model that uses fewer parameters, e.g., a model for faster neural transform operations coupled with a smaller set of parameters (e.g., 100,000). The selected machine learning model may have architecture and weights optimized for training on the edge device with the corresponding constraints, and thus may operate smoothly (e.g., with little response time) once deployed to the corresponding edge device.

The deployment engine 230 may be configured to deploy a machine learning model to a target device. The machine learning model for deployment can be a trained machine learning model or an untrained machine learning model, as described above. When deploying a machine learning model to a target device (e.g., an edge device), the deployment engine 230 may first check the constraints of the target device. The deployment engine 230 then selects a proper machine learning model developed by the model development engine 210 (with or without training by the model training engine 220) based on the constraints of the target device. In some embodiments, if a machine learning model is developed and/or trained on an edge device 103, the machine learning model can be directly deployed on the edge device, or to another cloud or edge device.

In some embodiments, a machine learning model developed and/or trained on an edge device 103a can be also deployed to another edge device 103b that has similar constraints. For example, a machine learning model developed on a desktop computer may be deployed to a laptop that may have similar constraints.

In some embodiments, if the target device is an edge device (e.g., an edge device), a deployed machine learning model may have:
◯ no communication with the cloud device, running entirely on the edge device and generating predictions for data passed as input from a user device;
◯ intermittent one-way communication, for example from the model management server to the edge device, to update the machine learning model (also referred to as “edge model” if it is deployed to an edge device) whenever a new version is available, or when the user or device constraints change or there is a change in the input data; and/or
◯ two-way communication between the model management server and the edge device - for example, if the edge device detects some changes in data or prediction quality, the edge device may preemptively communicate with the model management server to start training a new model. In this scenario, the model management server or the edge device does not need to send any user data to the other side (e.g., for a personalized model), instead, the edge device only needs to send relevant metadata or information that enables the machine learning model to be trained and updated accordingly.

In some embodiments, a deployed machine learning model may be further customized by a user, enterprise, application, device, or a combination thereof. For example, a machine learning model developed by the model management server 101 for a specific edge device 103 may be further optimized for system choices such as privacy, personalization, modeling and/or efficiency, so that the deployed machine learning model can adapt to the specifications of a given application scenario. The specific processes for model deployment as well as model development and training are further described with reference to different application scenarios, as further illustrated in FIGS. 3A-6.

FIG. 3A illustrates an example scenario where a machine learning model is trained with user information. As can be seen in the figure, when training the model, the user information (e.g., user data reflecting user preferences or user interests or other user-related features), the private key for the user, and the associated public key may be provided for training the model, to obtain a personalized AI engine. In some embodiments, a machine learning model may be trained for multiple users so that each user has a corresponding personalized AI engine through the training process. For example, as illustrated in FIG. 3A, when the user data and private key for user A and the associated public key are provided in the training process, the obtained AI engine is a personalized AI engine (A) for user A. When the user data and private key for user B and the associated public key are provided in the training process, the obtained AI engine is a personalized AI engine (B) for user B.

In some embodiments, when a personalized AI engine is generated for a user, if a different user or someone else without the exact user information (e.g., user-ID and password or private key) tries to access the personalized AI engine, the AI engine does not generate valid predictions (e.g., the generated AI predictions become unusable). In some embodiments, even if another user (or someone from a different enterprise division) gains access to the device (or cloud cluster) storage or memory, the AI engine will not generate the right predictions for incoming data (for example, the accuracy of the AI engine when accessed without the right user-ID/password can drop from 95% to 10% or lower, making it worse than chance or random guessing). As a result, the AI engine will be rendered useless to the attacker.

It is to be noted that, in some embodiments, the generated personalized AI engine may also have different tiers that correspond to different device constraint types. In one example, a personalized AI engine (e.g., AI engine (A)) may include three tiers of AI engines corresponding to different device constraint types. To achieve such an objective, device information for different device constraint types may be input together with the personal data or information in the training process, as shown in FIG. 3B where the device information 301 is input together with the user data, private key, and public key in the training process to obtain a set of personalized machine learning models. When the trained different tiers of machine learning models or AI engines are deployed to different devices with different constraints, a user can then access a personalized AI engine from these different devices, e.g., from a wearable device, a desktop computer, or from online access, wherein in each device or in the cloud, a different version of the AI engine (A) is included. The specific process for generating a personalized AI engine is further described in detail in FIGS. 4-6.

FIG. 4A illustrates an example process for generating a private key and a public key based on user information, according to some embodiments. As illustrated, a machine learning system 401 may include an AI key generator 403, e.g., the privacy engine 218 in the model training engine 220 may include an AI key generator. The AI key generator 403 may receive the user data 405, e.g., user-ID (e.g., user account) and password associated with the application provided by the machine learning model. Based on the received user data, the AI key generator 403 may generate a private key (e.g., a private key A for user A) and a public key, as illustrated in FIG. 4A.

A private key or public key (which is often a large number, or string of numbers and letters) is a piece of information used for scrambling data (e.g., input data for a machine learning model) so that it appears random. When unencrypted data, also called plaintext, is put into a cryptographic algorithm using the private key or public key, the plaintext comes out of the cryptographic algorithm as random-looking data, which can be decrypted back into plaintext form for a person with the right key. In the illustrated embodiment in FIG. 4A, a private key A and a public key is generated, where the public key may be used for encryption and the private key is used for decryption. For example, for data transmitted between a sender and a recipient, the data is encrypted with the recipient’s public key information (which may be available through a public-key directory), and the recipient then uses the private key to unscramble the message. Similarly, for the model training process, the public key may be used to encrypt the input data and the private key may be used to decrypt the model output. Accordingly, for a trained machine learning model, if there is no correct public key provided by a user, the model may not generate an output for the user, and if there is no correct private key provided by the user, the model may generate an incorrect output.

It is to be noted that, in some embodiments, while the public-key directory is “public” for search, the directory is stored in a secured database that only authenticated/valid users can access (e.g., with the send’s user-ID and password). For example, as illustrated in FIG. 4B, the disclosed machine learning system 401 may further include an AI permissions database 409, which may store the public-key directory and access information for the registered users. Accordingly, if a user is not authorized (e.g., by providing an invalid user-ID or password), access to the database 409 may return “access denied,” and thus the public key is not available to that user.

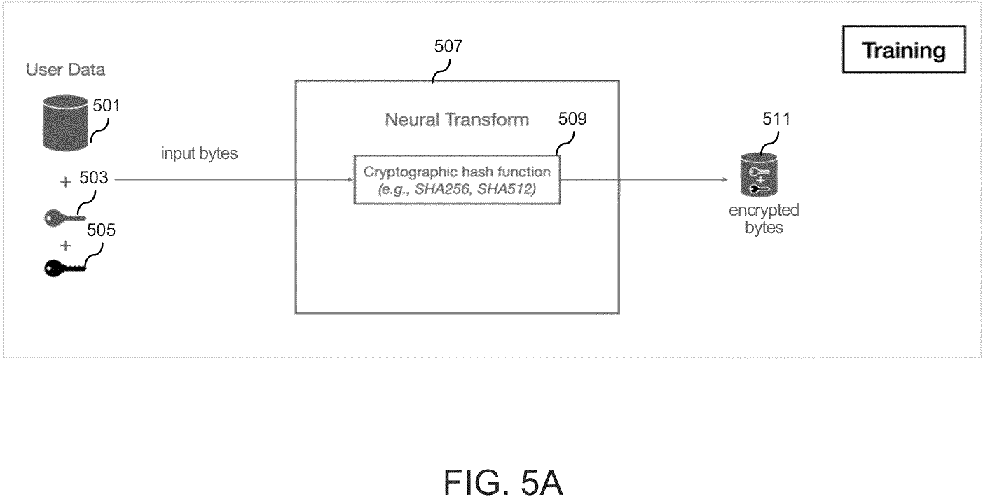

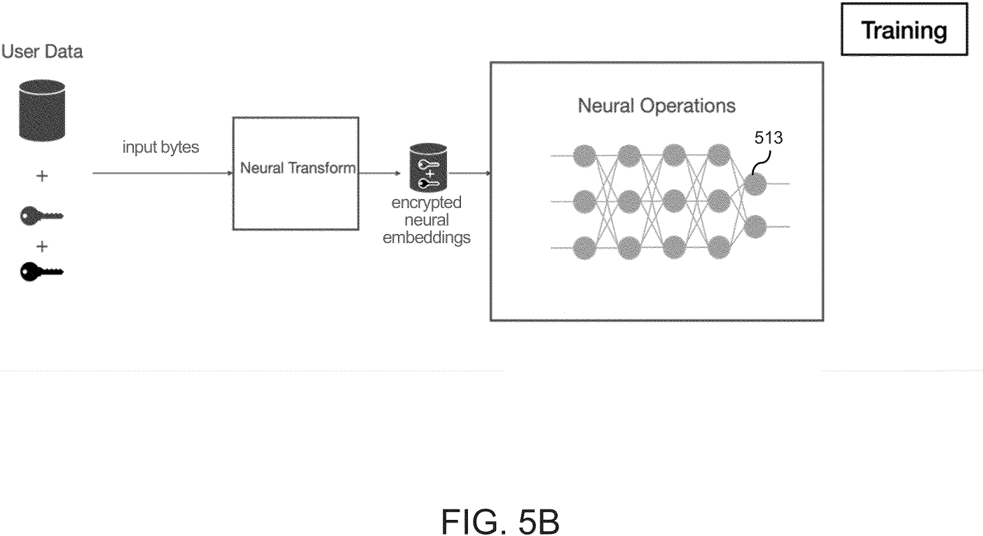

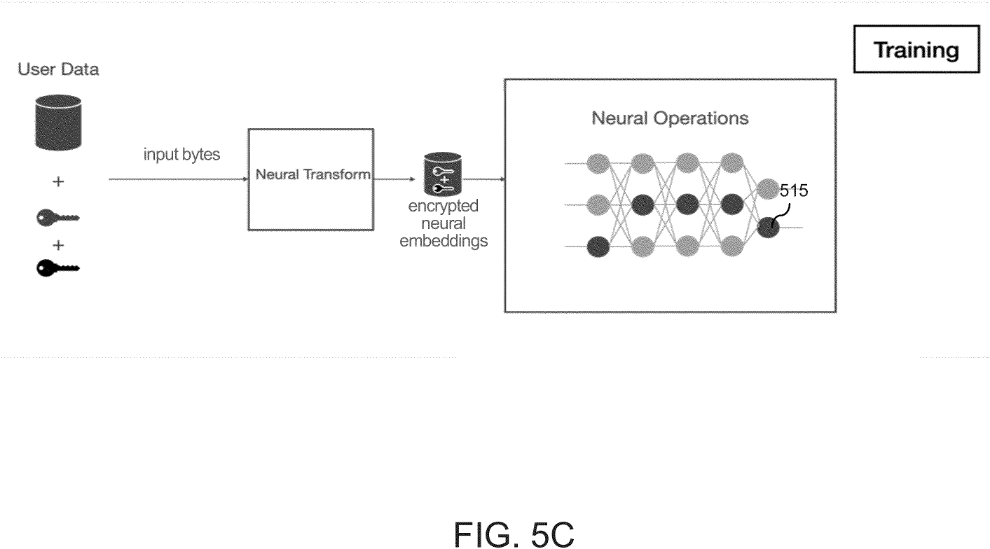

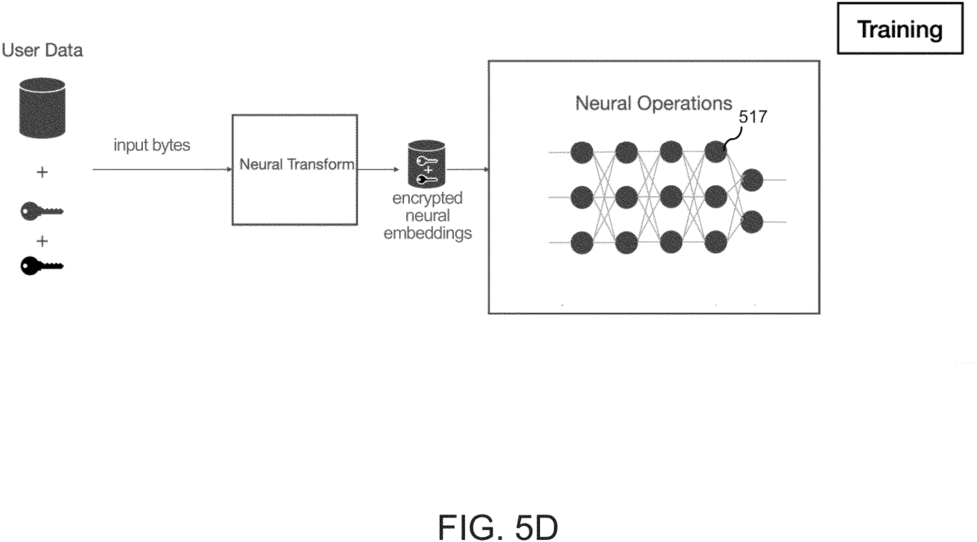

From the above, it can be seen that while the two keys are separate, they are related to one another. In addition, both keys are required in the encryption and/or decryption of the encrypted data. If a hacker has only one key, decryption is impossible, and thus the use of the private key and public key improves the level of security for the trained machine learning model. In some embodiments, once a private key for a user and the associated public key is generated, the keys may be used to encrypt/decrypt the input data in the model training process, as further described below. The specific processes for using the private key and public key for training a personalized and privacy-preserving machine learning model are further described in detail below in FIGS. 5A-5D.

Briefly, FIG. 5A illustrates an example process for converting the plaintext of input data into hypertext by using the private key and public key, FIG. 5B illustrates an example process for selecting proper neural operations for the hypertext, FIG. 5C illustrates an example process for obtaining partial weights for the machine learning model through one or more iterations during the training process, and FIG. 5D illustrates an example process for obtaining all the weights of the machine learning model to get a fully trained machine learning model. The specific process for FIGS. 5A-5D are further described in detail below.

FIG. 5A illustrates an example process for converting the plaintext of input data into hypertext by using the private key and public key pair. As illustrated, during the process, the user data 501, private key 503, and public key 505 are input to the machine learning system to perform a neural transform process 507. The user data 501 may include information reflecting user interests and preferences. The machine learning system may include a cryptographic hash function 509 configured to convert the plaintext of the user data into hypertext. The algorithm used by the cryptographic hash function 509 may be a SHA256, SHA512, or another different hash algorithm that is based on the non-linear functions and is configured to prevent any undesired decryption method, which is thus uncrackable. Briefly, the byte sequence of the input byte is encrypted, via the combined key using byte + context values, into encrypted bytes 511. The encrypted bytes may be represented as a neural embedding matrix, which may be then subject to the neural transform operations in the model training process.

FIG. 5B illustrates an example process for selecting proper neural operations for the hypertext, according to some embodiments. In some embodiments, the neural network included in the machine learning model may include multi-layer neural network parameters or weights (as indicated by the light dots 513 in FIG. 5B), which may be determined based on the dynamic embeddings, multi-layers of self-attention, and fully connected linear and non-linear operations. The specific operations (and the model output) may be determined based on the specific task provided by the user in the training of the machine learning model. For example, if the task of the machine learning model is for binary text classification, the specific operations are then selected to implement that task and generate an output, which is a single value between 0 and 1.

FIG. 5C illustrates an example of obtaining partial network weights during the training process, according to some embodiments. According to some embodiments, the model training is performed by optimizing the network weights (or model parameters). For example, during the training process, the neural network weights may be iteratively optimized and personalized for the user based on the keys and corresponding neural operations performed in the previous step. In one example, the network weights may be optimized (e.g., fitting parameters via gradient descent) based on the user-provided labeled data by using the backpropagation algorithm. Here, the user-labeled data may reflect user interests or user preferences and may be already converted to hypertext as described earlier. FIG. 5C illustrates an example scenario where partial network weights (as indicated by the dark dots 515) may be obtained through one or more iterations during the training process.

FIG. 5D illustrates an example process for obtaining all network weights through the training process, according to some embodiments. As described earlier, through continuous iterations, all network weights may be optimized and finalized to achieve a fully trained neural network or AI engine. In some embodiments, the number of iterations may be predefined. In some embodiments, the number of iterations may be dynamically determined, where the iteration may continue until the error does not significantly decrease. In some embodiments, there are additional means that determine when to stop the iterations. Once the iterations stop, the network weights are determined, and the neural network is considered trained. For example, as shown in FIG. 5D, all the dots 517 in the neural network become dark, which indicates all network weights are optimized through the iterations. At this point, a personalized machine learning model or AI engine is obtained. In some embodiments, a fully trained neural network or AI engine can be retained or optimized again.

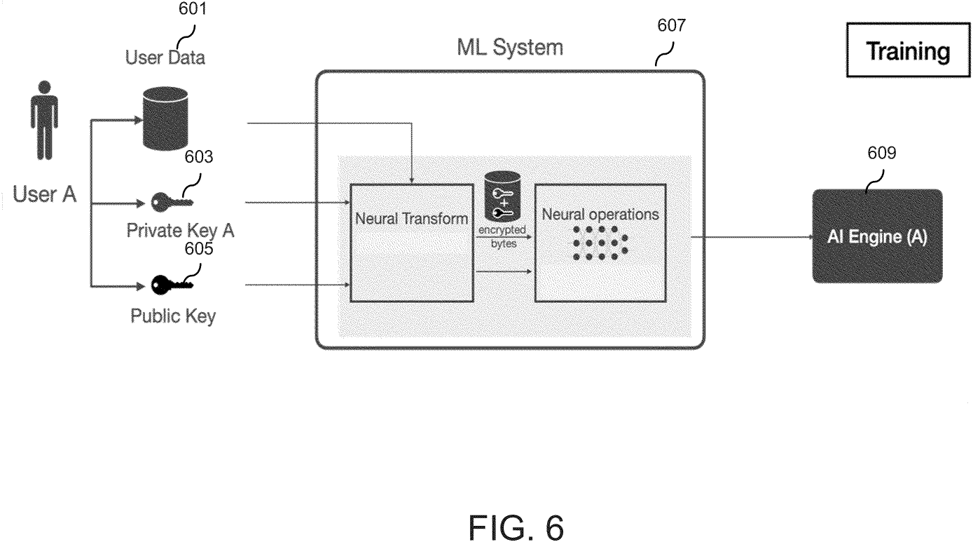

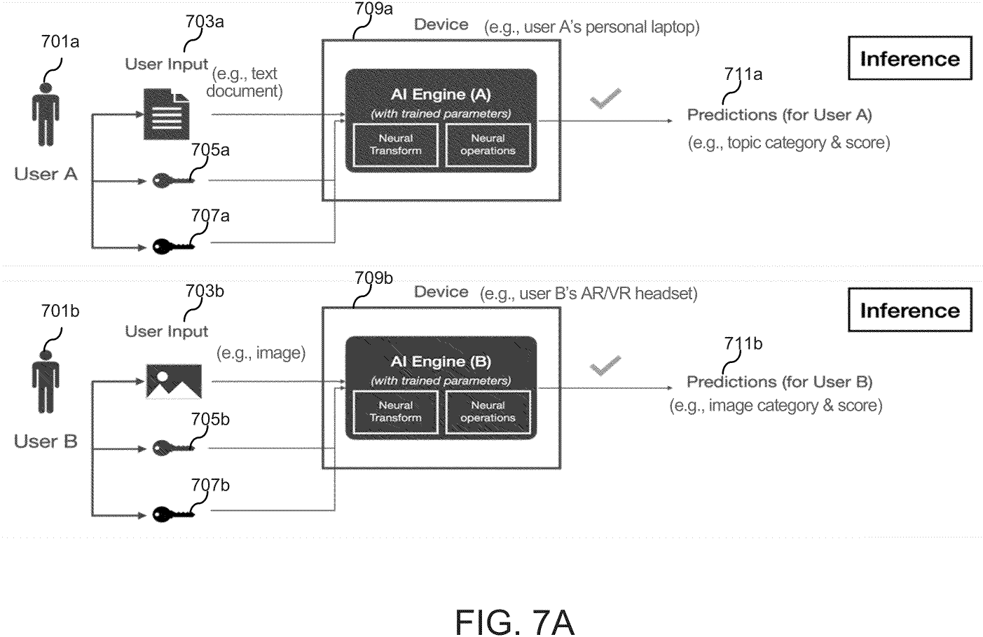

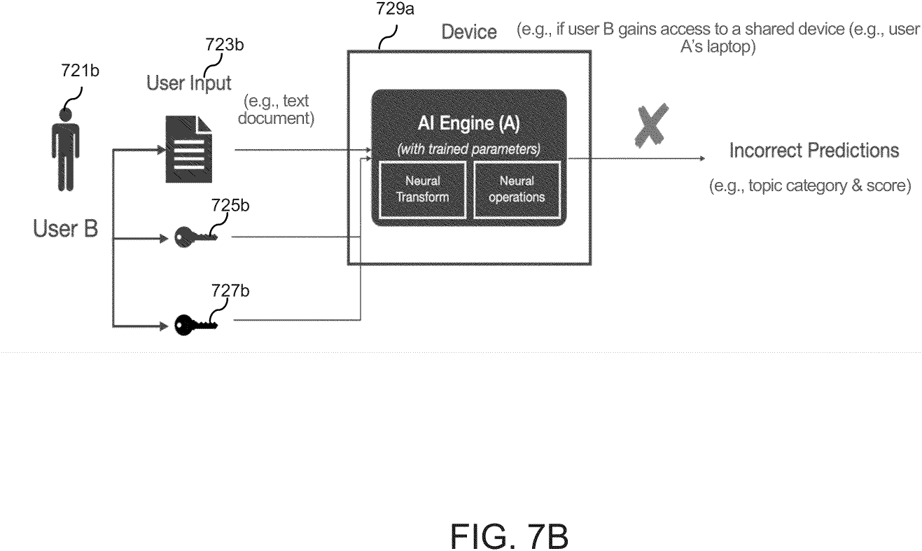

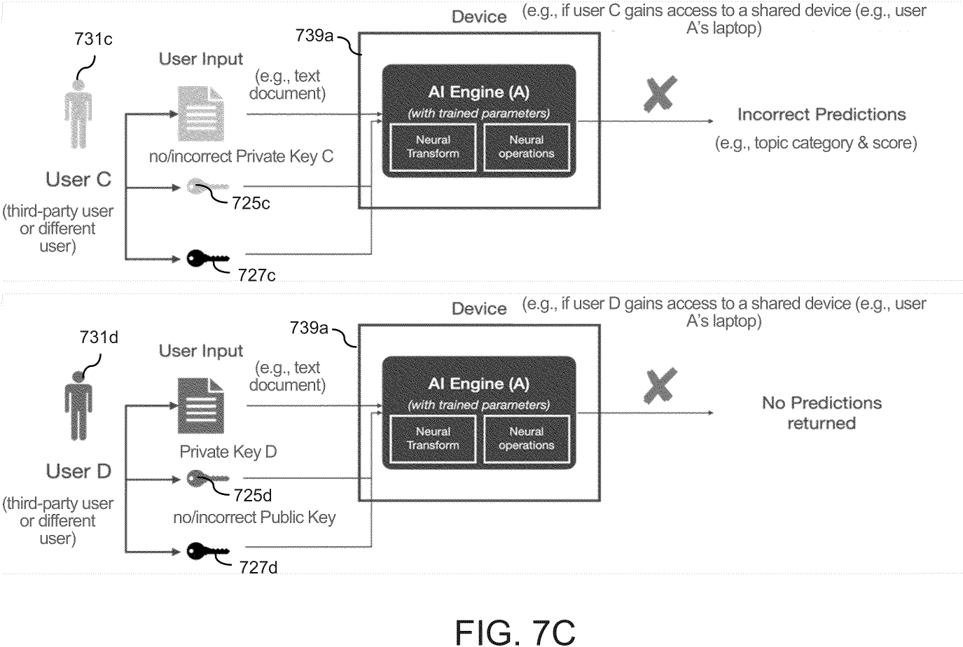

As an example, FIG. 6 illustrates a specific process for training a personalized AI engine (A) for user A, according to some embodiments. As illustrated, the user data 601, private key A 603, and the associated public key 605 for user A may be input into the machine learning system 607, which may perform a neural transform to convert plaintext of the user data 601 (e.g., user labeled text) into the hypertext via the SHA256, SHA512 or another different hash algorithm. The converted hypertext may then pass through multiple iterations to optimize the network weights for the neural network, to get a fully trained AI engine (A) 609 for user A. Similarly, if the input user data, the private key, and the associated public key are for user B, then an AI engine (B) may be also obtained for user B. In addition, as described earlier, in some embodiments, device information for target devices of different constraint types may be input together with the user data and the private/public key pair. In this way, a set of personalized machine learning models or AI engines may be trained to obtain personalized AI engines for different devices that may be accessed by the user. In the following, various application scenarios of personalized AI engines are further described with reference to FIGS. 7A-7C.

FIG. 7A illustrates example application scenarios of different personalized AI engines for different users, according to some embodiments. The application scenarios may be implemented by the reference engines of the machine learning systems associated with the users. According to one example, a user A 701a may provide input data 703a, along with the private key 705a and the associated public key 707a for user A to the AI engine (A) 709a, which is a personalized AI engine trained for topic categorization for the user A. As also indicated, the personalized AI engine (A) 709a may be trained for the personal laptop of user A (e.g., device information of the laptop of user A may be input into the training process). The trained AI engine (A) 709a may include parameters optimized for the user A. In the AI engine (A) 709a, the user input 703a (e.g., text) may be converted from the plaintext into hypertext based on the private key 705a and the public key 707a provided to the AI engine (A) 709a. The converted hypertext may be then subject to the neural transform operations implemented in the trained neural network to generate an output 711a, which is the prediction for the user A, e.g., a topic category identified for the user input 703a. The quality score for the model output may be also included in the output 711a. The output may be converted to plaintext when user A 701a provides the correct user information.

Similarly, according to another example, a user B 701b may provide input data 703b, along with the private key 705b and the associated public key 707b for user B to the AI engine (B) 709b, which is a personalized AI engine trained for image categorization for user B. As also indicated, the personalized AI engine (B) 709b may be trained for the personal AR/VR headset of the user B (e.g., device information associated with the AR/VR headset of the user B may be input into the training process of the AI engine (B)). The trained AI engine (B) 709b may include parameters optimized for the user B. In the AI engine (B) 709b, the user input 703b (e.g., image) may be converted to the hypertext (e.g., encrypted pixel values) based on the private key 705b and the public key 707b provided to the AI engine (B) 709b. The converted hypertext may be then subject to the neural transform operations implemented in the trained neural network to generate an output 711b, which is the prediction for the user B, e.g., an image category identified for the user input 703b. The quality score for the model output may be also included in the output 711b. The output may be converted to plaintext when user B 701b provides the correct user information.

FIG. 7B illustrates an example application scenario where a user accesses a personalized AI engine of another user, according to some embodiments. For example, a laptop may be shared between user A and user B (which may be different users from those in FIG. 7A). When accessing the shared laptop, user B 721b may find a personalized AI engine (A) 729a, which actually was trained for the user A but not the user B 721b. User B may provide user input 723b, the private key 725b, and associated public key 727b for the user B to the AI engine (A) 729a. When receiving an output generated by the AI engine (A) 729a, the output may be not what the user B 721b expects, since the prediction is an incorrect prediction where the accuracy of the prediction may be greatly reduced. Under certain circumstances, the accuracy of the AI engine when accessed without the right user-ID/password can drop from 95% to 10% or lower, making it worse than a chance or random guessing. Accordingly, the AI engine (A) 729A may be rendered useless to the user B 721b.

FIG. 7C illustrates example application scenarios where users access to a personalized AI engine of another user, according to some embodiments. Different from the application scenario illustrated in FIG. B, where user B 721b provides the correct private key and the associated public key, FIG. C illustrates application scenarios where user C or user D may not provide the correct private key or public key, respectively. As illustrated in FIG. 7C, when the user C 731c provides the correct public key 727c but does not provide the correct private key 725c, the personalized AI engine (A) 739a may output an incorrect prediction for the user C 731c. When the user D 731d provides the correct private key D 725d but does not provide the correct public key 727d, the AI engine (A) 739a does not even generate an output. That is, there is no prediction returned at this moment. The reason may be due to the rejected access to the AI engine according to the AI permission database, as described earlier in FIG. 4B.

In some embodiments, privacy-preserving AI engines may also provide the capability to enable password protection. That is, a personalized AI engine may be also password-protected for a particular user and application (where the password may be for the user account of the application). This may be implemented by using the user-ID (and optionally, application-ID) to customize or fine-tune the machine learning system to tie the model weights to the specific user. Once trained and deployed, relevant predictions from the AI engine can only be unlocked with the password that was originally used to customize the model. In some embodiments, the user-ID and password may be used to generate a pair of the private key and public key as described earlier in FIGS. 4A-4B, where the private/public key pair may be used to generate a personalized AI engine as described in FIGS. 5A-5D. The user-ID and password thus represent an additional level of protection for the trained personalized AI engine beyond the private/public key pair.

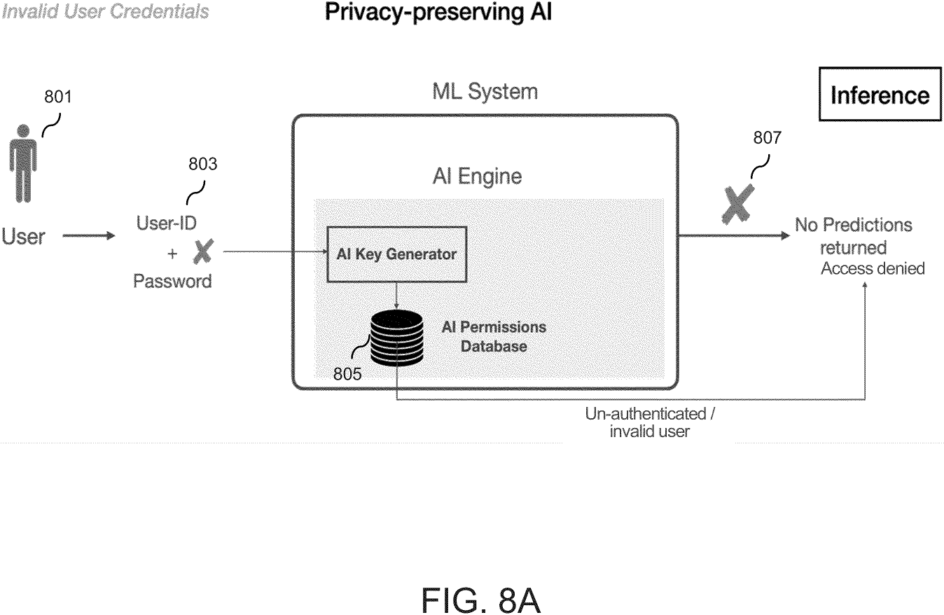

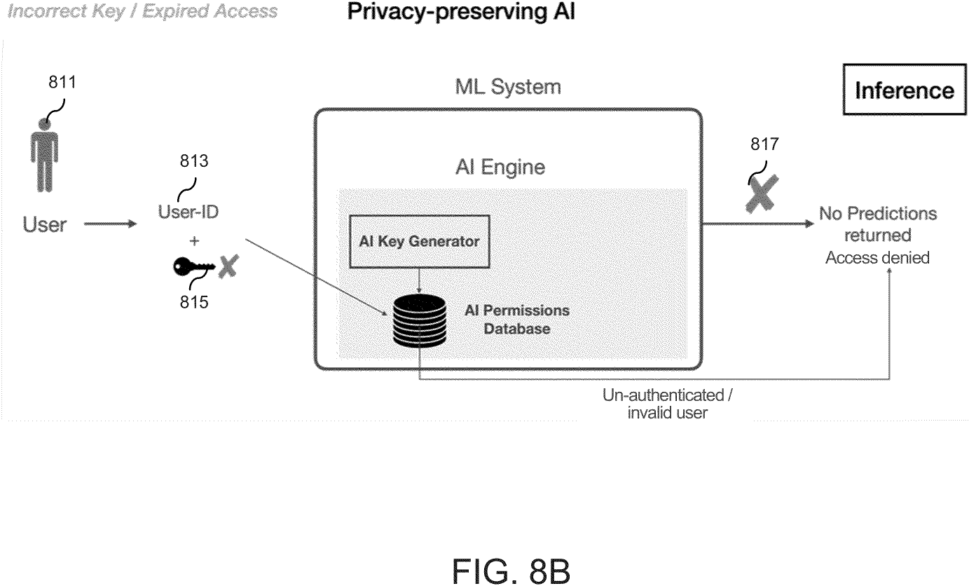

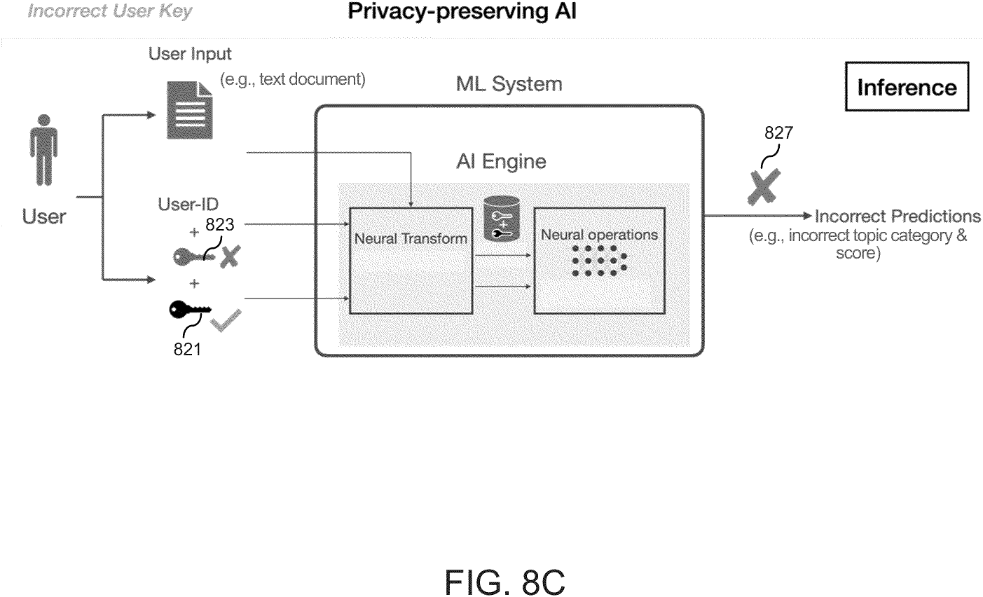

FIG. 8A illustrates an example application scenario where an AI system enforces password-protected privacy, according to some embodiments. As illustrated, when a user 801 provides an invalid user-ID and/or password 803 for a personalized AI engine, since the user-ID and/or password are invalid, the user is not authorized according to the AI permissions database 805, and thus will not generate a private and public key pair, which then prevents a prediction to be performed, as indicated by the cross sign 807 in FIG. 8A.

FIG. 8B illustrates an example scenario where a user provides the correct user-ID but an incorrect public key, according to some embodiments. As illustrated, a user 811 may provide a correct user-ID 813 but does not provide the correct public key 815. Although not illustrated, the user may provide the correct private key of the user. However, since the public key is not provided, the access to the AI engine is also unauthenticated, and thus no prediction is returned, as indicated by the cross sign 817 in FIG. 8B.

FIG. 8C further illustrates an example application scenario wherein a user provides the correct user-ID and public key but the incorrect private key, according to some embodiments. As illustrated, the correct public key 821 is provided, which allows to access to the public-key directory and thus the AI engine is accessible. However, since the private key 823 is incorrect or is not provided, the personalized parameters may be not available in the prediction process by the AI engine, and thus the output is an incorrect prediction, as indicated by the cross sign 827 in FIG. 8C.

It is to be noted that the above scenarios illustrated in FIGS. 7A-8C are for exemplary purposes and not for limitations, and there may be additional application scenarios not illustrated in these figures. In addition, in some embodiments, a privacy-preserving AI engine may also provide the capability to enable private sharing. For example, a user may share a personalized AI engine with their trusted network using the same mechanism (e.g., as simple as sharing a password for the group). Under this scenario, the other users may use a shared user-ID (or group-ID) and password to customize and deploy the shared AI engine to their trusted user network.

In some embodiments, the various components 210, 220, 218, and 230 in the model management application 105 may implement these various application scenarios. In some embodiments, the above-described various application scenarios may be implemented on a computing system with access to a hard disc or remote storage, as further described in detail.

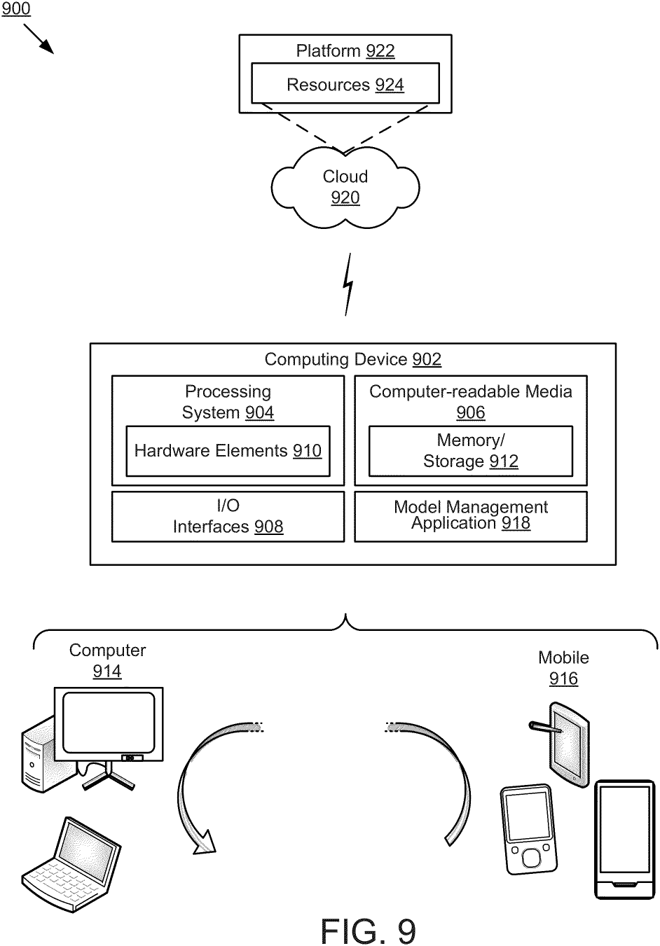

FIG. 9 illustrates an example system 900 that, generally, includes an example computing device 902 that is representative of one or more computing systems and/or devices that may implement the various techniques described herein. The computing device 902 may be, for example, an edge device 103, a cloud services unit 117, or a model management server 101 as shown in FIG. 1, an on-chip system embedded in a device (e.g., IoT), and/or any other suitable computing device or computing system.

The example computing device 902 as illustrated includes a processing system 904, one or more computer-readable media 906, and one or more I/O interfaces 908 that are communicatively coupled, one to another. Although not shown, the computing device 902 may further include a system bus or other data and command transfer system that couples the various components, from one to another. A system bus may include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of the functionality to perform one or more operations using hardware. Accordingly, the processing system 904 is illustrated as including hardware element 910 that may be configured as processors, functional blocks, and so forth. This may include implementation in hardware as an application-specific integrated circuit (ASIC) or other logic devices formed using one or more semiconductors. The hardware elements 910 are not limited by the materials from which they are formed, or the processing mechanisms employed therein. For example, processors may be comprised of semiconductor(s) and/or transistors, e.g., electronic integrated circuits (ICs). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random-access memory (RAM)) and/or nonvolatile media (such as read-only memory (ROM), Flash memory, optical disks, magnetic disks, and so forth). The memory/storage component 912 may include fixed media (e.g., RAM, ROM, a fixed hard drive, and so on) as well as removable media, e.g., Flash memory, a removable hard drive, an optical disc, and so forth. The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movements as gestures that do not involve touch), and so forth. Examples of output devices include a display device (e.g., a monitor or projector), speakers, a printer, a network card, a tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “unit,” “component,” and “engine” as used herein generally represent software, firmware, hardware, or a combination thereof. The features of the techniques described herein are platform-independent, meaning that the techniques may be implemented on a variety of commercial computing platforms having a variety of processors.

As previously described, hardware elements 910 and computer-readable media 906 are representatives of modules, engines, programmable device logic, and/or fixed device logic implemented in a hardware form that may be employed in one or more implementations to implement at least some aspects of the techniques described herein, such as to perform one or more instructions. Hardware may include components of an integrated circuit or on-chip system, an ASIC, a field-programmable gate array (FPGA), a complex programmable logic device (CPLD), and other implementations in silicon or other hardware. In this context, hardware may operate as a processing device that performs program tasks defined by instructions and/or logic embodied by the hardware as well as hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of an engine that is executable by the computing device 902 as software may be achieved at least partially in hardware, e.g., through the use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

As further illustrated in FIG. 9, the example system 900 enables ubiquitous environments for providing one or more device-specific AI engines, which can be further personalized. This improves the performance of an AI engine not only due to its compatibility with specific device constraints but also due to its personalized output.

In the example system 900, multiple devices are interconnected through a central computing device. The central computing device may be local to multiple devices or may be located remotely from the multiple devices. In one embodiment, the central computing device may be a cloud of one or more server computers that are connected to multiple devices through a network, the internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a family of target devices is created, and experiences are tailored to the family of devices. A family of devices may be defined by physical features, types of usage, or other common characteristics of the devices.

In various implementations, the computing device 902 may assume a variety of different configurations, such as for computer 914 and mobile 916 uses, and for many enterprise use, IoT user, and many other uses not illustrated in FIG. 9. Each of these configurations includes devices that may have generally different constructs and capabilities, and thus the computing device 902 may be configured according to one or more of the different device classes. For instance, the computing device 902 may be implemented as the computer 914 family of a device that includes a personal computer, desktop computer, multi-screen computer, laptop computer, netbook, and so on. The computing device 902 may also be implemented as the mobile 916 family of devices that include mobile devices, such as a mobile phone, a portable music player, a portable gaming device, a tablet computer, a wearable device, a multi-screen computer, and so on. In some embodiments, the devices may be classified according to their constraints instead, as described earlier.

The techniques described herein may be supported by these various configurations of the computing device 902 and are not limited to the specific examples of the techniques described herein. This is illustrated through the inclusion of a model management application 918 on the computing device 902, where the model management application 918 may include different units or engines as illustrated in FIGS. 1-2. The functionality represented by the model management application 918 and other modules/applications may also be implemented all or in part through the use of a distributed system, such as over a “cloud” 920 via a platform 922 as described below.

The cloud 920 includes and/or is representative of platform 922 for resources 924. The platform 922 abstracts the underlying functionality of hardware (e.g., servers) and software resources of the cloud 920. Resources 924 may include applications and/or data that can be utilized while computer processing is executed on servers that are remote from the computing device 902. Resources 924 can also include services provided over the internet and/or through a subscriber network, such as a cellular or Wi-Fi network.

The platform 922 may abstract resources and functions to connect the computing device 902 with other computing devices 914 or 916. The platform 922 may also serve to abstract the scaling of resources to provide a corresponding level of scale to encountered demand for the resources 924 that are implemented via platform 922. Accordingly, in an interconnected device implementation, the implementation functionality described herein may be distributed throughout system 900. For example, the functionality may be implemented in part on the computing device 902 as well as via the platform 922 that abstracts the functionality of the cloud 920.

While this disclosure may contain many specifics, these should not be construed as limitations on the scope of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Under certain circumstances, multitasking and parallel processing may be utilized. Moreover, the separation of various system components in the implementations described above should not be understood as requiring such separation in all implementations, and it should be understood that the described program components and systems may generally be integrated together into a single software or hardware product or packaged into multiple software or hardware products.

Some systems may use certain open-source frameworks for storing and analyzing big data in a distributed computing environment. Some systems may use cloud computing, which may enable ubiquitous, convenient, on-demand network access to a shared pool of configurable computing resources (e.g., networks, servers, storage, applications, and services) that may be rapidly provisioned and released with minimal management effort or service provider interaction.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situations where only the disjunctive meaning may apply.

What is claimed is:

1. A computer-implemented method of training a machine learning model, comprising:
receiving user information for a user;
generating a private key and a public key for the user based on the user information;
receiving input bytes containing user-specific features;
feeding the input bytes, the private key, and the public key into a machine learning model;
training the machine learning model based on the received input bytes, the private key, and the public key; and
generating a personalized machine learning model for the user based on the training of the machine learning model.

2. The computer-implemented method of claim 1, wherein the user information comprises user identification information and password associated with an application.

3. The computer-implemented method of claim 1, prior to training the machine learning model, the method further comprises:
converting the input bytes into encrypted bytes based on the private key and the public key.

4. The computer-implemented method of claim 3, wherein the encrypted bytes are represented as a neural embedding matrix.

5. The computer-implemented method of claim 3, wherein training the machine learning model comprises dynamic embedding of the encrypted bytes and performing one or more layers of linear or nonlinear neural applications.

6. The computer-implemented method of claim 1, wherein training the machine learning model comprises optimizing parameters of the machine learning model to reflect the user-specific features.

7. The computer-implemented method of claim 1, wherein obtaining a personalized machine learning model for the user comprises obtaining a first personalized machine learning model for a first user and obtaining a second personalized machine learning model for a second user.

8. The computer-implemented method of claim 7, wherein the first personalized machine learning model includes a first set of model parameters optimized for the first user and the second personalized machine learning model includes a second set of model parameters optimized for the second user.

9. The computer-implemented method of claim 7, wherein, when the first user accesses the second personalized machine learning model without providing user information associated with the second user, the second personalized machine learning model generates an output with an accuracy below a threshold or does not generate an output.

10. The computer-implemented method of claim 1, prior to training the machine learning model, the method further comprises:
receiving device information of a device intended to run the personalized machine learning model for the user; and
training the machine learning model based on the input bytes, the private key, the public key, and the device information of the device.

11. A system for training a machine learning model, comprising:
a processor; and
a memory, coupled to the processor, configured to store executable instructions that, when executed by the processor, cause the processor to perform operations including:
receiving user information for a user;
generating a private key and a public key for the user based on the user information;
receiving input bytes containing user-specific features;
feeding the input bytes, the private key, and the public key into a machine learning model;
training the machine learning model based on the received input bytes, the private key, and the public key; and
generating a personalized machine learning model for the user based on the training of the machine learning model.

12. The system of claim 11, wherein the user information comprises user identification information and password associated with an application.

13. The system of claim 11, prior to training the machine learning model, the executable instructions further cause the processor to perform operations including:
converting the input bytes into encrypted bytes based on the private key and the public key.

14. The system of claim 13, wherein the encrypted bytes are represented as a neural embedding matrix.

15. The system of claim 13, wherein training the machine learning model comprises dynamic embedding of the encrypted bytes and performing one or more layers of linear or nonlinear neural applications.

16. The system of claim 11, wherein training the machine learning model comprises optimizing parameters of the machine learning model to reflect the user-specific features.

17. The system of claim 11, wherein obtaining a personalized machine learning model for the user comprises obtaining a first personalized machine learning model for a first user and obtaining a second personalized machine learning model for a second user.

18. The system of claim 17, wherein the first personalized machine learning model includes a first set of model parameters optimized for the first user and the second personalized machine learning model includes a second set of model parameters optimized for the second user.

19. The system of claim 17, wherein, when the first user accesses the second personalized machine learning model without providing user information associated with the second user, the second personalized machine learning model generates an output with an accuracy below a threshold or does not generate an output.

20. The system of claim 11, prior to training the machine learning model, the executable instructions further cause the processor to perform operations including:
receiving device information of a device intended to run the personalized machine learning model for the user; and
training the machine learning model based on the input bytes, the private key, the public key, and the device information of the device.
